(19) United States
(12) Patent Application Publication
(10) Pub. No.: US 2020/0302401 A1
(43) Pub. Date: Sep. 24, 2020

(54) INFORMATION PROCESSING APPARATUS, INFORMATION PROCESSING SYSTEM, AND NON-TRANSITORY COMPUTER READABLE MEDIUM

(71) Applicant: FUJI XEROX CO., LTD., Tokyo (JP)

(72) Inventor: Koki TOSHIMITSU, Kanagawa (JP)

(73) Assignee: FUJI XEROX CO., LTD., Tokyo (JP)

(21) Appl. No.: 16/517,036

(22) Filed: Jul. 19, 2019

(30) Foreign Application Priority Data
Mar. 19, 2019 (JP) 2019-051942

(51) Int. Cl. G06Q 10/10; G06Q 10/06

(52) U.S. Cl. CPC G06Q 10/1091; G06Q 10/063114; G06Q 10/105

(57) ABSTRACT

An information processing apparatus includes an acquisition unit and a notification unit. The acquisition unit acquires working results including work start time and work end time in multiple companies for which a worker works, worker information identifying the worker, pieces of company information indicating the respective companies, and prescribed working hour periods in respective contracts concluded with the respective companies. The notification unit calculates working hour periods in the respective companies and makes a notification of each of the working hour periods. The notification unit calculates the working hour periods by using the respective working results, the worker information, the respective pieces of company information, and the respective prescribed working hour periods that are acquired by the acquisition unit.

### CROSS-REFERENCE TO RELATED APPLICATIONS

This application is based on and claims priority under 35 USC 119 from Japanese Patent Application No. 2019-051942 filed Mar. 19, 2019.

### BACKGROUND

### (i) Technical Field

The present disclosure relates to an information processing apparatus, an information processing system, and a non-transitory computer readable medium.

### (ii) Related Art

Japanese Unexamined Patent Application Publication No. 2014-154105 describes an attendance-information management server including a time-recording management unit, an attendance-state classified-total unit, an alarm-setting recording unit, and a notification processing unit. The time-recording management unit records time as an attendance result on the assumption that successfully performed biometric authentication corresponds to time recording. If the time is recorded, the attendance-state classified-total unit classifies and totals pieces of information regarding attendance results and acquires working hour information. The alarm-setting recording unit holds information regarding an alarm message and an alarm sound corresponding to a threshold based on the labor standards. If the working hour information acquired by the attendance-state classified-total unit exceeds the threshold based on the labor standards registered in advance in the alarm-setting recording unit, the notification processing unit acquires the corresponding alarm message, displays the alarm message together with the result of the time recording on a terminal installed in the store, acquires the information regarding the corresponding alarm sound, and outputs the information.

### SUMMARY

In a case where a worker works for multiple companies, for example, for one mainly and the other on the side or works part-time for the companies, it has not been possible to determine whether totaled working hours exceed the legal working hours. Aspects of non-limiting embodiments of the present disclosure relate to an information processing apparatus, an information processing system, and a non-transitory computer readable medium that are enabled to total working hours in multiple companies for a worker who works for the multiple companies and to perform attendance-information management.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including an acquisition unit and a notification unit. The acquisition unit acquires working results including work start time and work end time in multiple companies for which a worker works, worker information identifying the worker, pieces of company information indicating the respective companies, and prescribed working hour periods in respective contracts concluded with the respective companies. The notification unit calculates working hour periods in the respective companies and makes a notification of each of the working hour periods. The notification unit calculates the working hour periods by using the respective working results, the worker information, the respective pieces of company information, and the respective prescribed working hour periods that are acquired by the acquisition unit.

### BRIEF DESCRIPTION OF THE DRAWINGS

An exemplary embodiment of the present disclosure will be described in detail based on the following figures, wherein:

FIG. 1 is a diagram illustrating the schematic configuration of an information processing system according to this exemplary embodiment;

FIG. 2 is a block diagram illustrating the configuration of the principal parts of the electric system of an image forming apparatus according to this exemplary embodiment;

FIG. 3 is a functional block diagram of an information processing terminal and an attendance-information management server in the information processing system according to this exemplary embodiment;

FIG. 4 is a table illustrating an example attendance-information-manager information table;

FIG. 5 is a table illustrating an example company information table;

FIG. 6 is a table illustrating an example plant information table;

FIG. 7 is a table illustrating an example worker information table;

FIG. 8 is a table illustrating an example of registration in an attendance information table performed when a worker goes to Company A;

FIG. 9 is a table illustrating an example of registration in the attendance information table performed when the worker leaves Company A;

FIG. 10 is a table illustrating an example of registration in the attendance information table performed when the worker goes to Company B;

FIG. 11 is a table illustrating an example of registration in the attendance information table performed when the worker leaves Company B;

FIGS. 12A and 12B are views illustrating an example of prescribed working hours displayed when 9:00 is input as the work start time in Company A serving as a company (X);

FIGS. 13A and 13B are views illustrating an example of a working result displayed when 15:00 is input as the work end time in Company A serving as the company (X);

FIGS. 14A and 14B are views illustrating an example of latest time within the legal working hours displayed when 16:00 is input as the work start time in a company (Y) after leaving the company (X);

FIGS. 15A and 15B are views illustrating an example of hours exceeding the legal working hours displayed when 19:00 is input as the work end time in Company B serving as the company (Y);

FIG. 16 is a view illustrating an example notification of working results;

FIG. 17 is a view illustrating an example display screen for monthly working results;

FIG. 18 is a table illustrating an example display screen for annual working results;

FIG. 19 is a flowchart illustrating an example process flow in the attendance-information management server in the information processing system according to this exemplary embodiment;

FIG. 20 is a flowchart illustrating the example process flow (process after a connector A) in the attendance-information management server in the information processing system according to this exemplary embodiment;

FIG. 21 is a flowchart illustrating the example process flow (process after a connector B) in the attendance-information management server in the information processing system according to this exemplary embodiment; and

FIG. 22 is a table illustrating an example of overtime work hours based on prescribed working hours for each of plants of the corresponding company.

### DETAILED DESCRIPTION

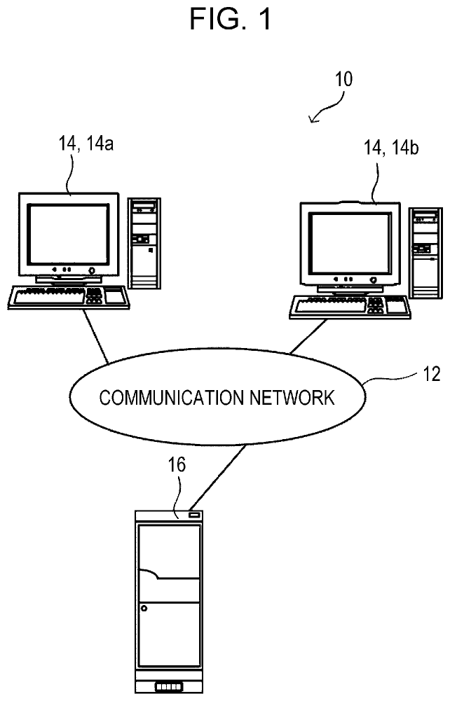

Hereinafter, an example of this exemplary embodiment will be described in detail with reference to the drawings. In this exemplary embodiment, an information processing system including multiple information processing apparatuses and a server that are connected to each other via a communication network that is one of various networks and the like will be described taken as an example. FIG. 1 is a diagram illustrating the schematic configuration of an information processing system 10 according to this exemplary embodiment.

As illustrated in FIG. 1, the information processing system 10 according to this exemplary embodiment includes multiple information processing terminals 14a, 14b, . . . and an attendance-information management server 16 serving as an information processing apparatus. When the information processing terminals 14a, 14b, . . . do not have to be discriminated from each other in the description, a letter suffixed to reference numeral is omitted in some cases. Although the example in which the multiple information processing terminals 14a, 14b, . . . are provided is described in this exemplary embodiment, one information processing terminal 14 may be provided.

The information processing terminals 14 and the attendance-information management server 16 are connected to each other via a communication network 12 such as a local area network (LAN), a wide area network (WAN), the Internet, or an intranet. The information processing terminals 14 and the attendance-information management server 16 are each enabled to mutually transmit and receive various pieces of data via the communication network 12.

The information processing system 10 according to this exemplary embodiment provides an attendance-information management service by which, for example, as a cloud service, the attendance-information management server 16 manages information regarding attendance in multiple companies. In the attendance-information management service, for example, a worker accesses the attendance-information management server 16 from the information processing terminal 14 operated by the worker and thereby may register information such as work start time and work end time and browse attendance information and the like stored in the attendance-information management server 16. The information processing terminals 14 include the information processing terminal 14a operated by an attendance-information manager and the information processing terminal 14b operated by the worker. In some cases, the information processing terminal 14a operated by the attendance-information manager is hereinafter referred to as an attendance-information-manager terminal 14a, and the information processing terminal 14b operated by the worker is referred to as a worker terminal 14b. A mobile terminal such as a smartphone may apply to the worker terminal 14b.

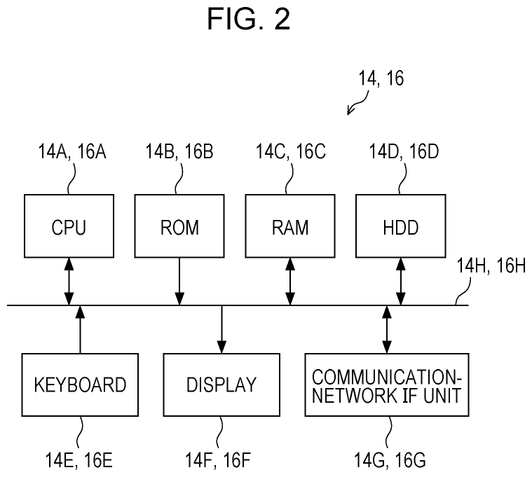

The configuration of the principal parts of the electric system of each information processing terminal 14 and the attendance-information management server 16 according to this exemplary embodiment will be described. FIG. 2 is a block diagram illustrating the configuration of the principal parts of the electric system of the information processing terminals 14 and the attendance-information management server 16 in the information processing system 10 according to this exemplary embodiment. The information processing terminals 14 and the attendance-information management server 16 basically have the configuration of a general computer, and thus the information processing terminals 14 will be described as a representative.

As illustrated in FIG. 2, each information processing terminal 14 according to this exemplary embodiment includes a central processing unit (CPU) 14A, a read-only memory (ROM) 14B, a random access memory (RAM) 14C, a hard disk drive (HDD) 14D, a keyboard 14E, a display 14F, and a communication network interface (IF) unit 14G. The CPU 14A controls overall operations of the information processing terminal 14. The ROM 14B stores therein various control programs, various parameters, and the like in advance. The RAM 14C is used as a work area or the like when the CPU 14A runs various programs. The HDD 14D stores therein various pieces of data, application programs, and the like. The keyboard 14E is used to input various pieces of information. The display 14F is used to display various pieces of information. The communication-network IF unit 14G is connected to the communication network 12 and transmits and receives various pieces of data to and from a different apparatus connected to the communication network 12. The above-described components of the information processing terminal 14 are mutually electrically connected via a system bus 14H. Although the HDD 14D is used as a memory in the information processing terminal 14 according to this exemplary embodiment, the exemplary embodiment is not limited to this. A different nonvolatile memory such as a flash memory may also apply to the memory.

With the configuration described above, in the information processing terminal 14 according to this exemplary embodiment, the CPU 14A accesses the ROM 14B, the RAM 14C, and the HDD 14D, acquires various pieces of data with the keyboard 14E, and displays various pieces of information on the display 14F. In the information processing terminal 14, the CPU 14A also controls transmission and reception of communication data via the communication-network IF unit 14G.

In the thus configured information processing system 10 according to this exemplary embodiment, the attendance-information management server 16 provides the attendance-information management service as a cloud service as described above. The attendance-information management server 16 according to this exemplary embodiment provides the attendance-information management service for performing integrated management of attendance in multiple companies in a case where a worker works for the multiple companies, for example, for one mainly and the other on the side or works part-time for the companies.

In attendance-information management systems in the related art, determination regarding a threshold based on the labor standards for attendance time is performed only in one company.

Suppose a case where a worker works for multiple companies, for example, for one mainly and the other on the side or works part-time for the companies. Even though working hours do not exceed the legal working hours (eight hours per day according to the Labor Standards Act in Japan) on a per company basis, the liability for paying an increased wage (an overtime allowance) to the employee arises in some cases depending on prescribed working hours in a contract with a company or a plant. In other cases, even though working hours exceed prescribed working hours in a contract with a plant, the liability for paying the overtime allowance to the employee does not arise.

For example, a worker having a service contract to work four hours as prescribed working hours with the business operator of a company (X) concludes a new service contract, with the business operator of a company (Y), to work four hours as prescribed working hours on the same day as the prescribed working day in the plant of the company (X). If the worker works in the plant of the company (X) and the plant of the company (Y) according to the respective service contracts, working hours on the day are eight hours and correspond to labor within the legal working hours. In contrast, if the worker works in the plant of the company (X) for five hours and then in the plant of the company (Y) for four hours, the prescribed working hours in one day has reached a total of eight hours. The business operator of the plant of the company (X) is not allowed to have the worker work without a conclusion or notification of a labor agreement regarding overtime work. If the business operator of the company (X) has the worker work in excess of the legal working hours, the business operator has the liability for paying an increased wage.

In another example, a worker having a service contract to work three hours as prescribed working hours with the business operator of the company (X) concludes a new service contract, with the business operator of the company (Y), to work three hours as prescribed working hours on the same day as the prescribed working day in the plant of the company (X). If the worker works in the plant of the company (X) and the plant of the company (Y) according to the respective service contracts, working hours per day are six hours and correspond to labor within the legal working hours. If the business operator of the company (X) extends the working hours for 2 hours, working hours in a day of the worker including the prescribed working hours in the plant of the company (Y) at the time when the labor in the plant of the company (X) ends are within the legal working hours, and the business operator of the plant of the company (X) does not have the liability for paying an increased wage or the like. In contrast, suppose a case where the worker works in the plant of the company (X) for five hours and then in the plant of the company (Y) for four hours. The case where the working hours are extended in the plant of the company (Y) applies to overtime work outside of the legal working hours. The business operator of the plant of the company (Y) is not allowed to have the worker work without a conclusion or notification of a labor agreement regarding overtime work. The business operator has the reliability for an increased wage for the extended one hour.

The attendance-information management server 16 according to this exemplary embodiment provides the attendance-information management service in which the attendance-information management server 16 is enabled to total working hours in multiple companies and perform attendance-information management in a case where a worker works for the multiple companies, for example, for one mainly and the other on the side or works part-time for the companies including the above described cases.

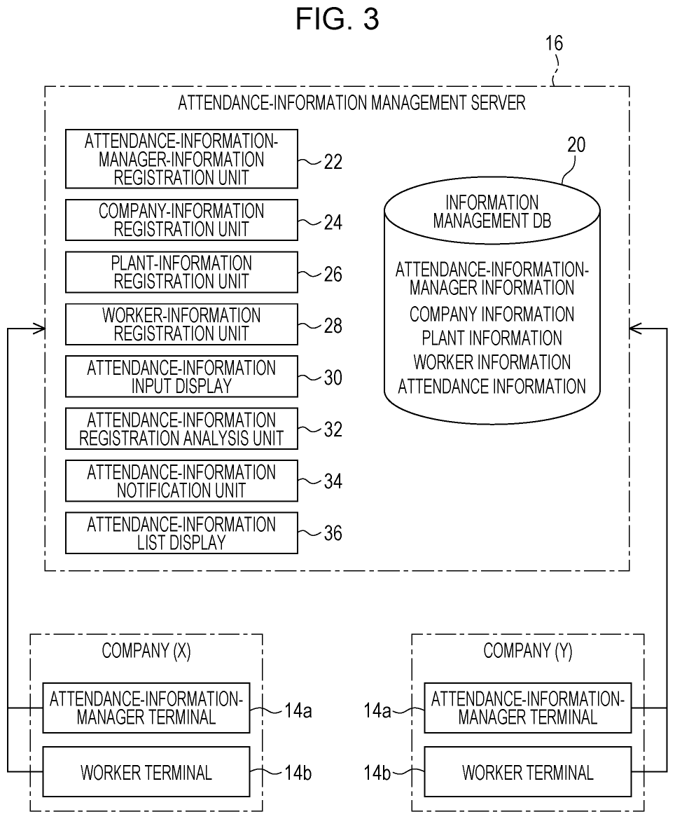

The functional configuration of the information processing terminals 14 and the attendance-information management server 16 in the information processing system 10 according to this exemplary embodiment that is configured as described above will be described. FIG. 3 is a functional block diagram of the information processing terminals 14 and the attendance-information management server 16 in the information processing system 10 according to this exemplary embodiment. In FIG. 3, the information processing terminal 14a operated by the attendance-information manager is depicted as the attendance-information-manager terminal 14a, and the information processing terminal 14b operated by the worker is depicted as the worker terminal 14b.

The attendance-information management server 16 has functions of an information management database (DB) 20, an attendance-information-manager-information registration unit 22, a company-information registration unit 24, a plant-information registration unit 26, and a worker-information registration unit 28. The attendance-information management server 16 also has functions of an input attendance-information display 30, an attendance-information registration analysis unit 32, an attendance-information notification unit 34, and an attendance-information list display 36. Note that the input attendance-information display 30 corresponds to an acquisition unit, and the input attendance-information display 30, the attendance-information registration analysis unit 32, the attendance-information notification unit 34, and the attendance-information list display 36 correspond to a notification unit.

The information management DB 20 stores therein attendance-information-manager information registered by the attendance-information-manager-information registration unit 22, company information registered by the company-information registration unit 24, plant information registered by the plant-information registration unit 26, and worker information registered by the worker-information registration unit 28, and other pieces of information. Attendance information acquired by the input attendance-information display 30 is also stored therein.

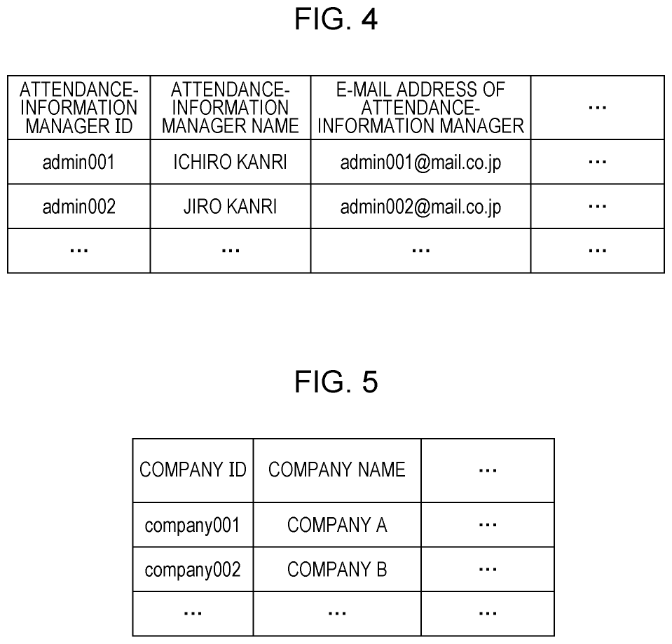

The attendance-information-manager-information registration unit 22 registers information regarding an attendance-information manager of each company. For example, the attendance-information manager of each company operates the attendance-information-manager terminal 14a and thereby registers the attendance-information manager for accessing the attendance-information management server 16. Specifically, the attendance-information manager registers user information such as the name of the attendance-information manager and the e-mail address of the attendance-information manager. The attendance-information manager ID for identifying the attendance-information manager is thereby assigned. The attendance-information manager of the company registers the information regarding the attendance-information manager in an attendance-information-manager information table in such a manner as to directly access attendance-information management server 16 or receive e-mail or the like publicly notified from an attendance-information manager of a different company. FIG. 4 illustrates an example attendance-information-manager information table. In the example in FIG. 4, the attendance-information-manager information table illustrates an example in which the name of an attendance-information manager, the e-mail address of the attendance-information manager, and the like are registered for each assigned attendance-information manager ID.

The company-information registration unit 24 registers information regarding a company. For example, the attendance-information manager of the company operates the attendance-information-manager terminal 14a, sets the company name or the like, and thereby newly registers company information in the attendance-information management server 16. The company ID for identifying the company is thereby assigned. The attendance-information manager of the company registers the company information in a company information table in such a manner as to directly access the attendance-information management server 16 or receive e-mail or the like publicly notified from the attendance-information manager of the different company. FIG. 5 illustrates an example company information table. The example in FIG. 5 illustrates an example in which a company name or the like is registered for each assigned company ID.

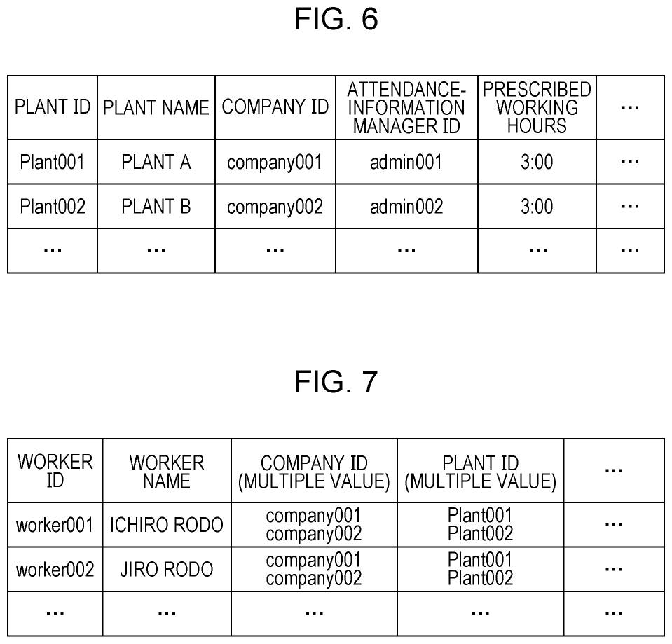

The plant-information registration unit 26 registers information regarding a plant of each company. For example, the attendance-information manager of the company operates the attendance-information-manager terminal 14a and thereby registers the plant associated with the company ID in the attendance-information management server 16. The plant ID for identifying the plant is thereby assigned. The plant name, the prescribed working hours, the attendance-information manager ID, and the like are set as the plant information. The attendance-information manager of the company registers the plant information in a plant information table in such a manner as to directly access the attendance-information management server 16 or receive e-mail or the like publicly notified from an attendance-information manager of a different company. FIG. 6 illustrates an example plant information table. The example in FIG. 6 illustrates an example in which the plant name, the company ID, and the attendance-information manager ID are registered for each assigned plant ID.

The worker-information registration unit 28 registers information regarding a worker working for companies. For example, an attendance-information manager of the company (X) operates the attendance-information-manager terminal 14a and thereby registers the worker name associated with the plant ID (multiple value) in the attendance-information management server 16. The worker ID for identifying the worker name is thereby assigned. For example, the attendance-information manager of the company (X) sets the company (X) as a first workplace of the worker. In response to the application from the worker with an in-house document, the attendance-information manager of the company (X) sets the disclosure of the worker information to a specific company (the company (Y) in this example). The attendance-information manager of the company (Y) receives a disclosure notification with e-mail or the like. The attendance-information manager of the company (Y) searches for the worker name and sets the company (Y) as a second workplace of the worker. However, if the prescribed working hours in the company (Y) exceed the legal working hours when the prescribed working hours in the company (X) are added to the prescribed working hours in the company (Y), the setting operation for adding the company information is prohibited. FIG. 7 illustrates an example worker information table. The example in FIG. 7 illustrates an example in which the worker name, one or more company IDs, one or more plant IDs, and the like are registered for each assigned worker ID.

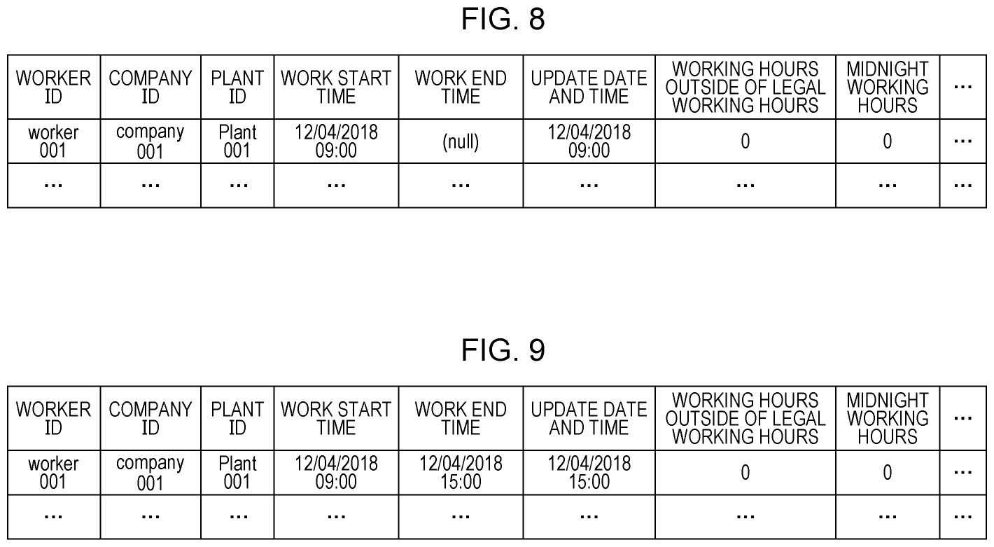

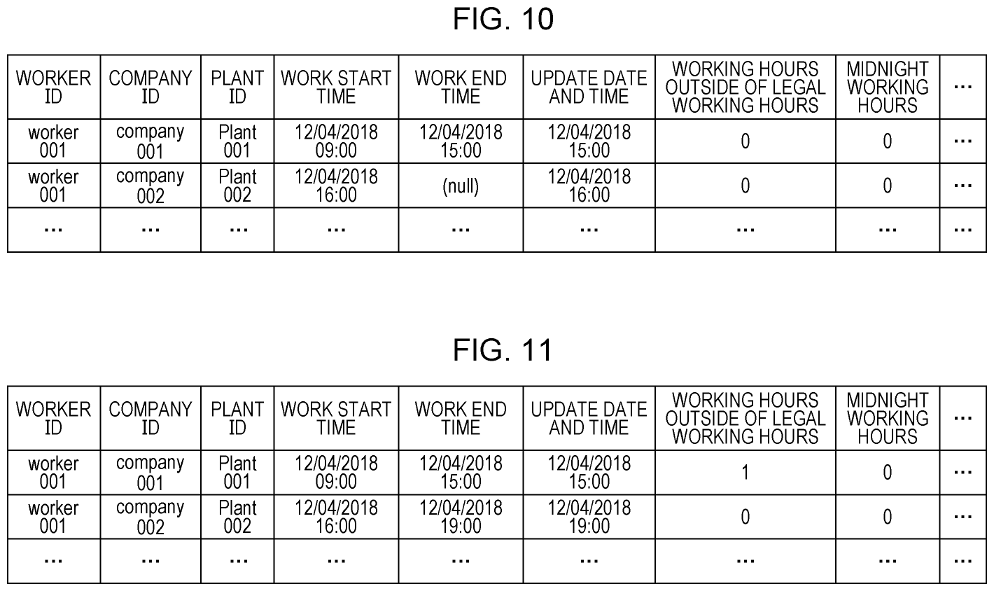

The input attendance-information display 30 inputs attendance information when the worker goes to or leaves a company. Specifically, the input attendance-information display 30 acquires the attendance information (a working result such as work start time and work end time) input by the worker by operating the worker terminal 14b at the start of working or at the end of working and registers the attendance information in the attendance information table. For example, the attendance information indicating the work start time or the work end time is input through operation of the worker terminal 14b, and the worker information, the company information, the plant information, and the attendance information are thereby transmitted to the attendance-information management server 16. The input attendance-information display 30 receives these pieces of information and registers the pieces of information in the attendance information table. FIGS. 8 to 11 illustrate example registration in the attendance information table. The examples in FIGS. 8 and 9 illustrate examples in which a company ID, a plant ID, work start time, work end time, update date and time, working hours outside of the legal working hours, midnight working hours, and the like are registered for each worker ID. FIG. 8 illustrates example registration performed when a worker 1 goes to Company A, and FIG. 9 illustrates example registration performed when the worker 1 leaves Company A. FIG. 10 illustrates example registration performed when the worker 1 goes to Company B, and FIG. 11 illustrates example registration performed when the worker 1 leaves Company B. Note that the input attendance-information display 30 may acquire the worker information and the attendance information from the worker terminal 14b and acquire the company information and the plant information that are associated with the worker information from the information management DB 20.

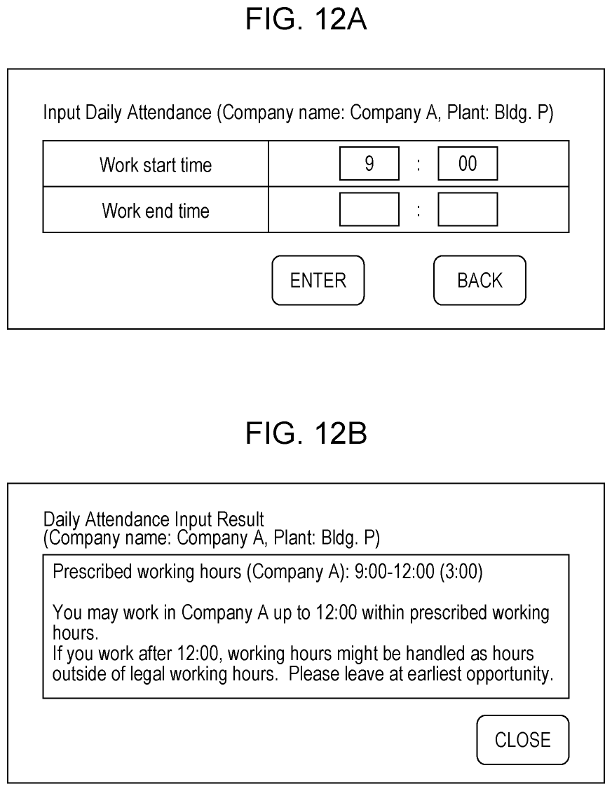

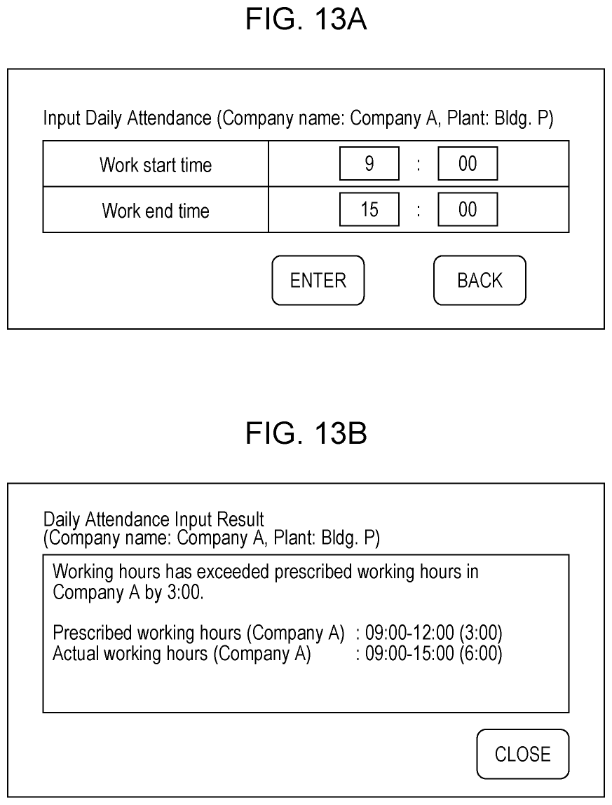

When the worker goes to the company (X) and inputs the work start time, the input attendance-information display 30 displays the prescribed working hours in the company (X) on the worker terminal 14b. When the worker leaves the company (X) and inputs the work end time, the input attendance-information display 30 displays the working result in the company (X) on the worker terminal 14b. The work start time or the work end time as the working result is input by operating, for example, a daily-attendance input screen as illustrated in FIG. 12A, 13A, 14A, or 15A, and thereby a daily-attendance input-result screen is displayed. The example in FIG. 12B illustrates an example of prescribed working hours displayed when 9:00 is input as the work start time in Company A serving as the company (X). The example in FIG. 13B illustrates an example of a working result displayed when 15:00 is input as the work end time in Company A serving as the company (X).

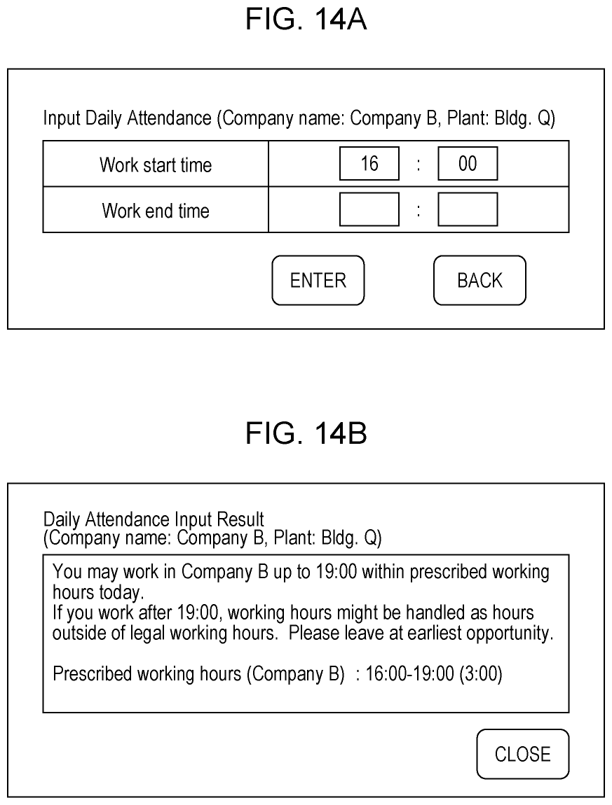

After the worker works and then leaves the company (X), and when the worker goes to the company (Y) and inputs work start time, the input attendance-information display 30 displays the latest time within the legal working hours in the company (X) on the worker terminal 14b. For example, the example in FIG. 14B illustrates an example of the latest time within the legal working hours that is displayed when 16:00 is input as the work start time in Company B serving as the company (Y) after leaving Company A serving as the company (X).

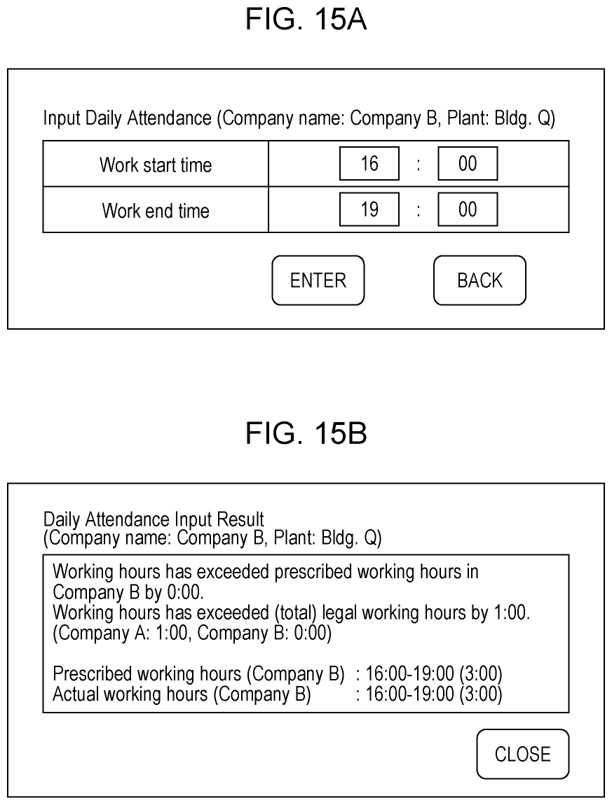

Further, when the worker inputs the work end time after leaving the company (Y), the input attendance-information display 30 displays, on the worker terminal 14b, hours exceeding the legal working hours in each of the company (X) and the company (Y). For example, the example in FIG. 15B illustrates an example of hours exceeding the legal working hours displayed when 19:00 is input as the work end time in Company B serving as the company (Y).

By using the attendance information, the worker information, the company information, and the prescribed working hours, the attendance-information registration analysis unit 32 calculates the content to be displayed on the worker terminal 14b by the input attendance-information display 30, working hours in each of the multiple companies, and the like. For example, the attendance-information registration analysis unit 32 calculates overtime work hours to be assigned to one of the companies on the basis of the working hours calculated from the work start time and the work end time of the company (X), the prescribed working hours in the company (X), the working hours in the company (Y), and the prescribed working hours in the company (Y).

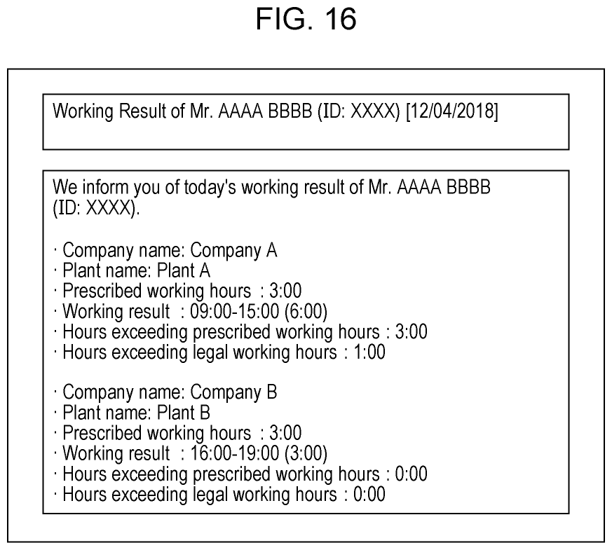

When the input attendance-information display 30 inputs work end time, and when the worker leaves a plant of a company, the attendance-information notification unit 34 notifies each attendance-information manager of the corresponding company of a working result. For example, the attendance-information notification unit 34 notifies each of the attendance-information manager of the company (X), the attendance-information manager of the company (Y), and the worker of the working result by using e-mail or the like to each e-mail address of a corresponding one of the attendance-information managers. Specifically, FIG. 16 illustrates an example notification of working results. The example in FIG. 16 illustrates an example of the notification of the working result in Company A serving as the company (X) and the working result in Company B serving as the company (X). The notification of each working result includes a name (worker ID), a company name, a plant name, prescribed working hours for a plant, a work start date and time, a work end date and time, hours exceeding the prescribed working hours, hours exceeding the legal working hours, and the like.

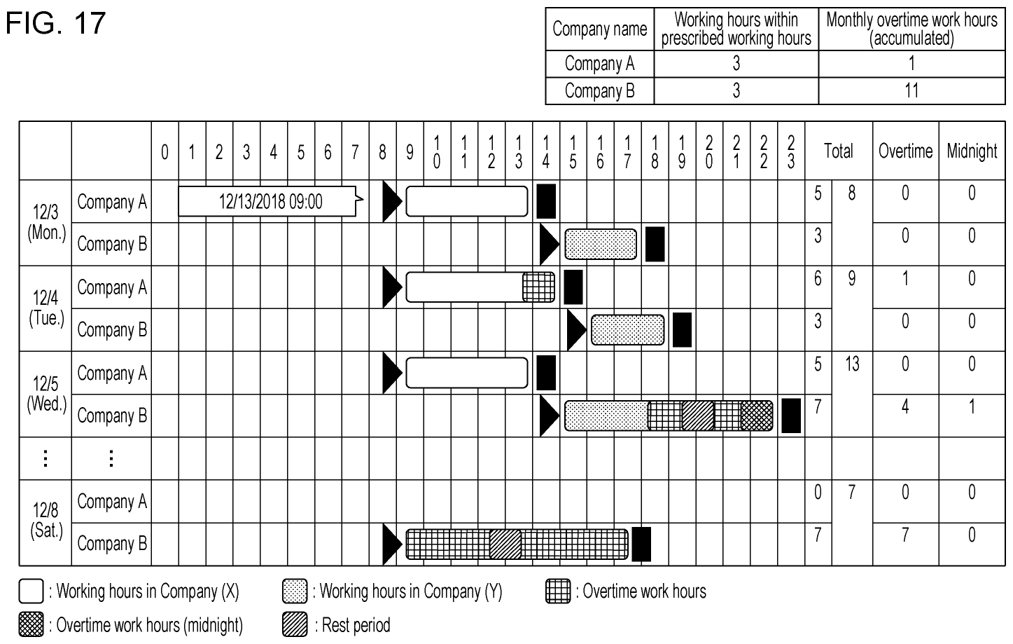

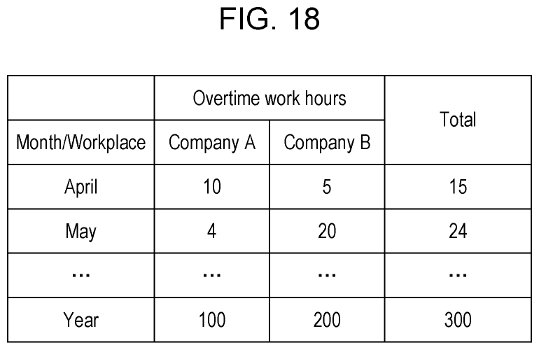

The attendance-information list display 36 displays a list of working results of the working by the worker in the company (X) and the company (Y). For example, if the acquisition of the working result list is requested from the information processing terminal 14 (the attendance-information-manager terminal 14a or the worker terminal 14b), the attendance-information list display 36 transmits the working result list and thereby displays the working result list on the information processing terminal 14. Specifically, the attendance-information list display 36 displays the working result list on at least one of a display screen for monthly working results as illustrated in FIG. 17 and a display screen for annual working results as illustrated in FIG. 18. FIG. 17 is a view illustrating an example display screen for the monthly working results, and FIG. 18 is a table illustrating an example display screen for the annual working results. A monthly working result list may also be displayed.

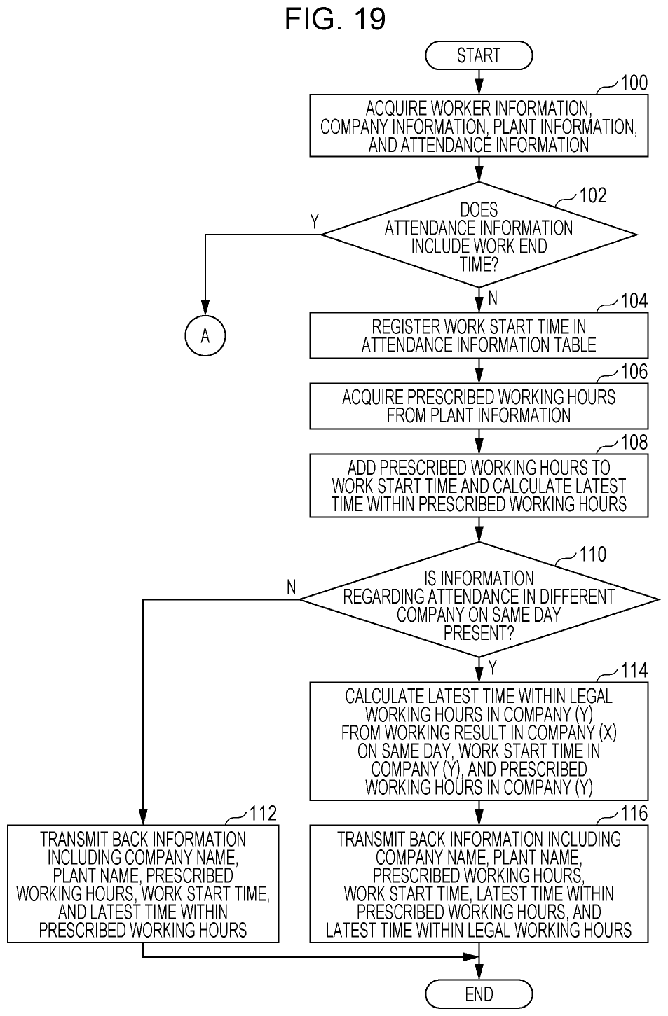

A specific process executed by the attendance-information management server 16 in the information processing system 10 according to this exemplary embodiment configured as described above will be described. FIGS. 19 to 21 are flowcharts illustrating an example flow of a process executed by the attendance-information management server 16 in the information processing system 10 according to this exemplary embodiment. The process in FIGS. 19 to 21 is started, for example, when the attendance information is input by using the daily-attendance input screen as illustrated in FIG. 12A, 13A, 14A, or 15A in such a manner that the worker terminal 14b is operated.

In step 100, the input attendance-information display 30 acquires worker information, company information, plant information, and attendance information, and the process moves to step 102. For example, the attendance information indicating work start time or work end time is input by operating the worker terminal 14b, the worker information, the company information, the plant information, and the attendance information are transmitted to the attendance-information management server 16, and the input attendance-information display 30 acquires these pieces of information. Note that the input attendance-information display 30 may acquire the worker information and the attendance information from the worker terminal 14b and acquire the company information and the plant information that are associated with the worker information from the information management DB 20.

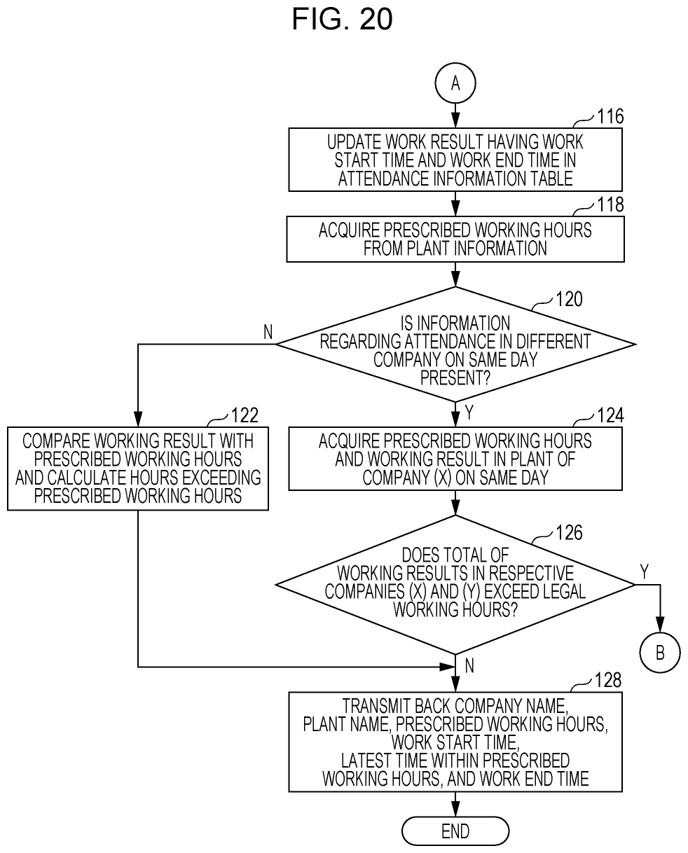

In step 102, the attendance-information registration analysis unit 32 determines whether the attendance information includes work end time. If the determination result is negative because the work end time is not included but work start time is included, the process moves to step 104. If the determination result is affirmative, the process moves to step 116 in FIG. 20.

In step 104, the input attendance-information display 30 registers the work start time in the attendance information table, and the process moves to step 106.

In step 106, the attendance-information registration analysis unit 32 acquires, from the plant information, prescribed working hours registered as the plant information in the information management DB 20, and the process moves to step 108.

In step 108, the attendance-information registration analysis unit 32 adds the prescribed working hours to the work start time and thereby calculates the latest time within the prescribed working hours, and the process moves to step 110.

In step 110, the attendance-information registration analysis unit 32 determines whether information regarding attendance in a different company on the same day is present. The determination is performed on the basis of the attendance information table stored in the information management DB 20. If the determination result is negative, the process moves to step 112. If the determination result is affirmative, the process moves to step 114.

In step 112, the input attendance-information display 30 transmits information including the company name, the plant name, the prescribed working hours, the work start time, and the latest time within the prescribed working hours back to the worker terminal 14b, and a series of steps is terminated. The daily-attendance input-result screen as illustrated in FIG. 12B is thereby displayed on the worker terminal 14b.

In contrast, in step 114, the attendance-information registration analysis unit 32 calculates the latest time within the legal working hours in the company (X) from the working result in the company (X) on the day, the work start time in the company (Y), and the prescribed working hours in the company (Y), and the process moves to step 116.

In step 116, the input attendance-information display 30 transmits information including the company name, the plant name, the prescribed working hours, the work start time, the latest time within the prescribed working hours, and the latest time within the legal working hours back to the worker terminal 14b, and the series of steps is terminated. The daily-attendance input-result screen as illustrated in FIG. 14B is thereby displayed on the worker terminal 14b. Note that FIG. 14B illustrates the example in which the latest time within the legal working hours is omitted.

In contrast, if the determination result in step 102 is affirmative, and if the process moves to step 116 illustrated in FIG. 20, the input attendance-information display 30 updates the working result having the work start time and the work end time in the attendance information table, and the process moves to step 118.

In step 118, the attendance-information registration analysis unit 32 acquires the prescribed working hours registered as the plant information from the plant information in the information management DB 20, and the process moves to step 120.

In step 120, the attendance-information registration analysis unit 32 determines whether information regarding attendance in a different company on the day is present. The determination is performed on the basis of the attendance information table stored in the information management DB 20. If the determination result is negative, the process moves to step 122. If the determination result is affirmative, the process moves to step 124.

In step 122, the attendance-information registration analysis unit 32 compares the working result with the prescribed working hours and calculates hours exceeding the prescribed working hours, and the process moves to step 128.

In contrast, in step 124, the attendance-information registration analysis unit 32 acquires the prescribed working hours and the working result in the plant of the company (X) on the day from the attendance information table stored in the information management DB 20, and the process moves to step 126.

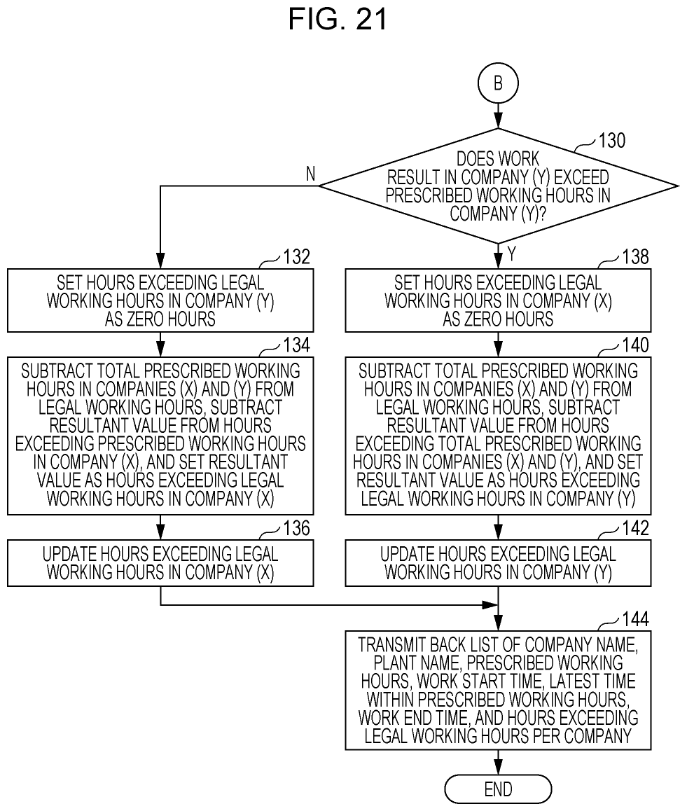

In step 126, the attendance-information registration analysis unit 32 determines whether the total of the working results in the company (X) and the company (Y) on the day exceeds the legal working hours. If the determination result is negative, the process moves to step 128. If the determination result is affirmative, the process moves to step 130 in FIG. 21.

In step 128, the input attendance-information display 30 transmits information including the company name, the plant name, the prescribed working hours, the work start time, the latest time within the prescribed working hours, and the work end time back to the worker terminal 14b, and the series of steps is terminated. The daily-attendance input-result screen as illustrated in FIG. 13B or 15B is thereby displayed on the worker terminal 14b. Alternatively, the attendance-information notification unit 34 may transmit the information including the company name, the plant name, the prescribed working hours, the work start time, the latest time within the prescribed working hours, and the work end time also to the attendance-information-manager terminal 14a with e-mail or the like.

In contrast, if the determination result in step 126 is affirmative, and if the process moves to step 130 illustrated in FIG. 21, the attendance-information registration analysis unit 32 determines whether the working result in the company (Y) exceeds the prescribed working hours in the company (Y). If the determination result is negative, the process moves to step 132. If the determination result is affirmative, the process moves to step 138.

In step 132, the attendance-information registration analysis unit 32 sets hours exceeding the legal working hours in the company (Y) as zero hours, and the process moves to step 134.

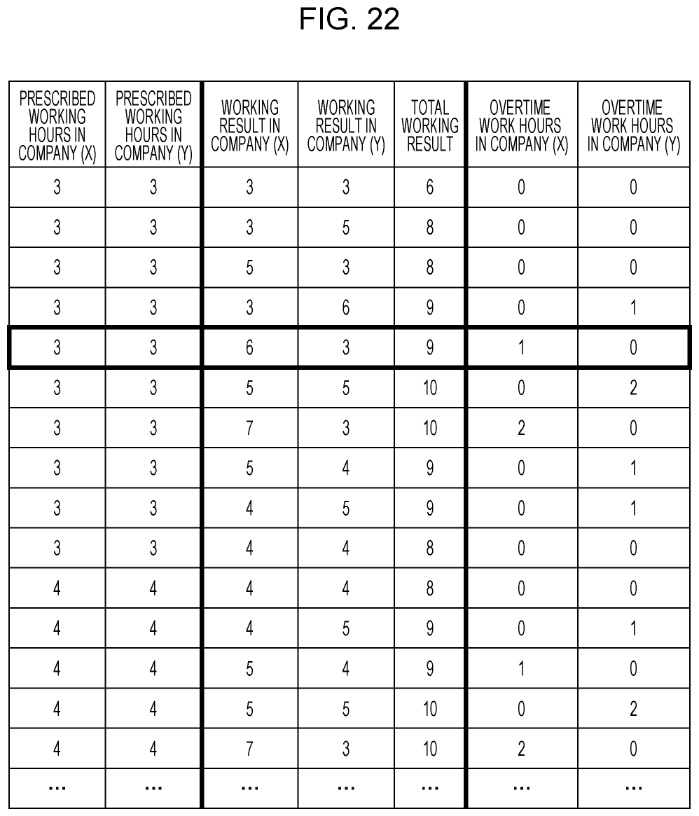

In step 134, the attendance-information registration analysis unit 32 subtracts the total prescribed working hours in the company (X) and the company (Y) from the legal working hours, subtracts the resultant value from hours exceeding the prescribed working hours in the company (X), and sets the resultant value as hours exceeding the legal working hours in the company (X). The process then moves to step 136. For example, as illustrated by thick lines in FIG. 22, two hours (a value obtained by subtracting six hours as the total prescribed working hours in the companies (X) and (Y) from eight hours as the legal working hours (eight hours-six hours)) are subtracted from three hours as the hours exceeding the prescribed working hours in the company (X) (six hours as the working result—three hours as the prescribed working hours). The resultant one hour is set as the hours exceeding the legal working hours in the company (X).

In step 136, the attendance-information registration analysis unit 32 updates the hours exceeding the legal working hours in the company (X) in the attendance information table stored in the information management DB 20, and the process moves to step 144.

In contrast, in step 138, the attendance-information registration analysis unit 32 sets the hours exceeding the legal working hours in the company (X) as zero hours, and the process moves to step 140.

In step 140, the attendance-information registration analysis unit 32 subtracts the total prescribed working hours in the company (X) and the company (Y) from the legal working hours, subtracts the resultant value from the hours exceeding the total prescribed working hours in the company (X) and the company (Y), and sets the resultant value as the hours exceeding the legal working hours in the company (Y). The process then moves to step 142.

In step 142, the attendance-information registration analysis unit 32 updates the hours exceeding the legal working hours in the company (Y) in the attendance information table stored in the information management DB 20, and the process moves to step 144.

In step 144, the input attendance-information display 30 transmits, back to the worker terminal 14b, information indicating a list of the company name, the plant name, the prescribed working hours, the work start time, the latest time within the prescribed working hours, the work end time, and the hours exceeding the legal working hours on a per company basis, and the series of steps is terminated. The daily-attendance input-result screen as illustrated in FIG. 15B is thereby displayed on the worker terminal 14b. Alternatively, the attendance-information notification unit 34 may transmit, as the working result, the list of the company name, the plant name, the prescribed working hours, the work start time, the latest time within the prescribed working hours, the work end time, and the hours exceeding the legal working hours on a per company basis also to the attendance-information-manager terminal 14a by using e-mail or the like. The working result, for example, as illustrated in FIG. 16 is thereby notified also to each attendance-information manager.

The action of the attendance-information management server 16 in the information processing system 10 according to this exemplary embodiment will be described by taking a specific example.

For example, the worker 1 works for Company A mainly and for Company B on the side. The worker 1 notifies the attendance-information manager of Company A of the working for Company B in addition to Company A.

The attendance-information manager of Company A performs user registration of the worker 1 in the attendance-information management server 16 and transmits, to the attendance-information-manager terminal 14a of the attendance-information manager of Company B, a request to perform attendance-information management of the worker 1 by using the attendance-information management server 16. The attendance-information manager of Company B agrees.

It is verified that the total prescribed working hours in Company A and Company B do not exceed the legal working hours. For example, the worker 1 has a service contract to work three hours a day as the prescribed working hours in a plant A of Company A. The worker 1 also has a service contract to work three hours a day as the prescribed working hours in a plant B of Company B. The worker 1 works in Company A weekdays, then moves to Company B, and works in Company B. Although the prescribed working hours in Company A are three hours, the worker 1 works in excess of the prescribed working hours in some cases in accordance with an order concerning business operations according to the content of the contract concluded with the plant A on the basis of Article 36 Agreement according to the Labor Standards Act. In addition, although the prescribed working hours in Company B are three hours, the worker 1 works in excess of the prescribed working hours in some cases in accordance with an order concerning business operations according to the content of the contract concluded with the plant B on the basis of Article 36 Agreement.

Under the above-described circumstances, the worker 1 works in Company A from 09:00 to 15:00 (6:00) on Tuesday, December 4, then moves to Company B in one hour, and works in Company B from 16:00 to 19:00 (3:00). The hours outside of the legal working hours at this time are 14:00-15:00 (1:00) in Company A.

The worker 1 may know the latest time within the prescribed working hours in Company A, as illustrated in FIG. 12B, from the daily-attendance input-result screen displayed on the worker terminal 14b when the worker 1 goes to Company A.

The worker 1 may also know hours exceeding the prescribed working hours in Company A, as illustrated in FIG. 13B, from the daily-attendance input-result screen displayed on the worker terminal 14b when the worker leaves Company A.

The worker 1 may know, from the daily-attendance input-result screen displayed on the worker terminal 14b when the worker 1 goes to Company B as illustrated in FIG. 14B, the latest time within the prescribed working hours in Company B and the latest time within the legal working hours in Company B that are obtained on the basis of the total of the working result in Company A and the working result in Company B.

The worker 1 may also know, from the daily-attendance input-result screen displayed on the worker terminal 14b when the worker 1 leaves Company B as illustrated in FIG. 15B, hours exceeding the prescribed working hours in Company B and hours exceeding the legal working hours that are obtained after totaling the working results in respective Company A and Company B, and thus may know hours exceeding the legal working hours and the name of the company applying to the exceeding hours.

The attendance-information managers of Company A and Company B are notified of the working results of the worker 1 in the respective companies on the day by the attendance-information notification unit 34 with the e-mail or the like. For example, the working results as illustrated in FIG. 16 are notified.

The attendance-information list display 36 transmits at least one of the working result lists respectively displayed on the monthly working-result display screen as illustrated in FIG. 17 and the annual working-result display screen as illustrated in FIG. 18 to each attendance-information-manager terminal 14a for the corresponding one of the attendance-information managers of Company A and Company B, and thereby a working result on a predetermined basis is displayed on the attendance-information-manager terminal 14a.

The exemplary embodiment has heretofore been described as the information processing system 10 including the attendance-information-manager terminal 14a, the worker terminal 14b, and the attendance-information management server 16 but is not limited to this system. For example, the exemplary embodiment may be an information processing system including the attendance-information-manager terminal 14a and the attendance-information management server 16 and may be an information processing system including the worker terminal 14b and the attendance-information management server 16.

The process executed by the attendance-information management server 16 according to the exemplary embodiment described above may be a process executed by software, hardware, or combination of these. The process executed by the attendance-information management server 16 may be distributed in such a manner as to be stored as a program in a recording medium.

The present disclosure is not limited to the exemplary embodiment described above. It goes without saying that the exemplary embodiment may be implemented in such a manner as not only described above but also to be modified variously without departing from the spirit of the disclosure.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
an acquisition unit that acquires working results including work start time and work end time in a plurality of companies for which a worker works, worker information identifying the worker, pieces of company information indicating the respective companies, and prescribed working hour periods in respective contracts concluded with the respective companies; and
a notification unit that calculates working hour periods in the respective companies and that makes a notification of each of the working hour periods, the notification unit calculating the working hour periods by using the respective working results, the worker information, the respective pieces of company information, and the respective prescribed working hour periods that are acquired by the acquisition unit.

2. The information processing apparatus according to claim 1,
wherein if the acquisition unit acquires the work start time in a company of the companies on a day, and if one of the working results that is in a different company of the companies on the day is present, the working result being associated with the worker indicated by the worker information acquired together with the work start time, the notification unit calculates legal time corresponding to a legal working hour period from the work start time acquired by the acquisition unit and a working hour period on the day calculated from the working result in the different company.

3. The information processing apparatus according to claim 2,
wherein if the acquisition unit acquires the work end time, and if the work end time is later than the legal time, the notification unit calculates a working hour period corresponding to overtime work by using each of the prescribed working hour periods.

4. The information processing apparatus according to claim 3,
wherein if a working hour period on the day calculated from one of the working results that is present in a company of the plurality of companies is within the prescribed working hour period provided for the company in one of the contracts that is concluded with the company, the notification unit makes a notification of the working hour period corresponding to the overtime work in a different company of the plurality of companies that applies to an excess of the prescribed working hour period.

5. The information processing apparatus according to claim 1,
wherein if the acquisition unit acquires the work start time in a company of the companies on a day, and if one of the working results that is in a different company of the companies on the day is not present, the working result being associated with the worker indicated by the worker information acquired together with the work start time, the notification unit calculates scheduled time by adding one of the prescribed working hour periods that is provided for the company to the work start time acquired by the acquisition unit and makes a notification of the scheduled time.

6. The information processing apparatus according to claim 1,
wherein if the acquisition unit acquires the work end time, the notification unit further makes a notification of the working result in each company.

7. The information processing apparatus according to claim 1,
wherein the notification unit computes classified total of the working results in each of the companies in a predetermined period and further makes a notification of a result of the classified total.

8. The information processing apparatus according to claim 7,
wherein the predetermined period is at least one of a period of one year and a period of one month.

9. An information processing system comprising:
the information processing apparatus according to claim 1; and
a worker terminal that transmits each of the working results and the worker information that are acquired by the acquisition unit of the information processing apparatus and that displays each of the working hour periods in the notification made by the notification unit of the information processing apparatus.

10. An information processing system comprising:
the information processing apparatus according to claim 1; and
an attendance-information-manager terminal that displays each of the working hour periods in the notification made by the notification unit of the information processing apparatus.

11. An information processing system comprising:
the information processing apparatus according to claim 1;
a worker terminal that transmits each of the working results and the worker information that are acquired by the acquisition unit of the information processing apparatus and that displays each of the working hour periods in the notification made by the notification unit of the information processing apparatus; and
an attendance-information-manager terminal that displays each of the working hour periods in the notification made by the notification unit.

12. A non-transitory computer readable medium storing a program causing a computer to execute a process executed by the information processing apparatus according to claim 1, the process comprising:
acquiring working results including work start time and work end time in a plurality of companies for which a worker works, worker information identifying the worker, pieces of company information indicating the respective companies, and prescribed working hour periods in respective contracts concluded with the respective companies; and
calculating working hour periods in the respective companies and making a notification of each of the working hour periods, the calculating of the working hour periods being performed by using the respective working results, the worker information, the respective pieces of company information, and the respective prescribed working hour periods that are acquired.
